(19) United States
(12) Patent Application Publication
(10) Pub. No.: US 2026/0154771 A1
(43) Pub. Date: Jun. 4, 2026

(54) OPTIMAL ALLOCATION FOR RIDESHARING

(71) Applicant: GRABTAXI HOLDINGS PTE. LTD., Singapore (SG)

(72) Inventors: Naureen AZEEZ, Karnataka, Bengaluru (IN); Joshua Mun Wei CHAN, Petaling Jaya (MY); Chee Hong LOONG, Petaling Jaya (MY); Sook Yee LIM, Petaling Jaya (MY); Ee Shen CHUA, Singapore (SG)

(21) Appl. No.: 19/123,569

(22) PCT Filed: Oct. 3, 2023
(86) PCT No.: PCT/SG2023/050661

§ 371 Date: Apr. 23, 2025

(30) Foreign Application Priority Data
Nov. 1, 2022 (SG) 10202251576S

(51) Int. Cl. G06Q 50/47; G06Q 10/0631

(52) U.S. Cl. CPC G06Q 50/47; G06Q 10/06312

(57) ABSTRACT

Systems and methods for allocation of a driver to a passenger by receiving a request for a ride from a passenger's computing device; identifying a set of candidate drivers for the ride based on location information in the request; determining, using a safety evaluation model, a ride safety score for each driver in the set of candidate drivers based on the driver's records and the passenger's records; determining a ride operational efficiency metric for each driver in the set of candidate drivers; allocating, using an allocation model, a designated driver to the passenger based on the ride safety score and the ride operational efficiency metric.

### TECHNICAL FIELD

This disclosure generally relates to methods and systems for optimal allocation of drivers to passengers in ridesharing services.

### BACKGROUND

This background is provided for generally presenting the context of the disclosure. Contents of this background section are neither expressly nor impliedly admitted as prior art against the present disclosure.

With the growth in ridesharing services, platforms enabling the ridesharing services have amassed a significant volume of data relating to drivers, passengers and rides undertaken by passengers. The volume of data relating to rides continues to grow exponentially with the ever-increasing reach of such services. The data may include data relating to the biographical details of the users of the rideshare system for security and authentication purposes. Data relating to riders (passengers) may include data of an origin, destination, time and review data relating to rides undertaken by the riders. The data amassed by the ridesharing platforms presents an opportunity to improve the experience and safety and proactively manage risks that may arise in the provision of the ridesharing service by leveraging the gathered data.

It is desired to address or ameliorate one or more disadvantages or limitations associated with the conventional systems and methods for allocation of drivers to passengers in a ridesharing service, or to at least provide a useful alternative.

### SUMMARY

The disclosure provides a system for allocation of a driver to a passenger, the system comprising: one or more processors (processor(s)); a memory accessible to the processor(s); a database comprising a plurality of passenger and driver records accessible to the processor(s); the memory comprising program code executable by the processor(s) to: receive a request for a ride from a passenger's computing device; identify a set of candidate drivers for the ride based on location information in the request; determine, using a safety evaluation model, a ride safety score for each driver in the set of candidate drivers based on the driver's records and the passenger's records; determine a ride operational efficiency metric for each driver in the set of candidate drivers; allocate, using an allocation model, a designated driver to the passenger based on the ride safety score and the ride operational efficiency metric.

The disclosure also provides a computer-implemented method for allocation of a driver to a passenger, the method comprising: receiving a request for a ride from a passenger's computing device; identifying a set of candidate drivers for the ride based location information in the request; determining, using a safety evaluation model, a ride safety score for each driver in the set of candidate drivers based on the driver's records and the passenger's records; determining a ride operational efficiency metric for each driver in the set of candidate drivers; allocating, using an allocation model, a designated driver to the passenger based on the ride safety score and the ride operational efficiency metric

### BRIEF DESCRIPTION OF THE DRAWINGS

Exemplary embodiments of the present invention are illustrated by way of example in the accompanying drawings in which like reference numbers indicate the same or similar elements and in which:

FIG. 1 illustrates a block diagram of a system for optimal allocation for ridesharing and its associated components;

FIG. 2 illustrates a flowchart for a method for optimal allocation for ridesharing; and

FIG. 3 illustrates a schematic diagram of allocation of a driver to a passenger by a conventional system; and

FIG. 4 illustrates a schematic diagram of allocation of a driver to a passenger by the disclosed methods.

### DETAILED DESCRIPTION

With the rise in popularity of ridesharing services, one challenge is ensuring the safety of both passengers and drivers by determining a more optimal allocation of drivers to passengers. In urban areas with a high degree of use of ridesharing services, typically at a point in time a substantial number of passengers are seeking drivers to provide them a ride. Conversely, a substantial number of drivers seek passengers. Allocation of drivers to passengers in a manner to optimize the safety and the experience of the passengers presents a significant computational challenge. With a substantial amount of driver and passenger related data available to the ridesharing platform, a great degree of meaningful information is available for deriving insights in assisting an optimal allocation. In addition, ridesharing platforms are under substantial latency constraints to ensure the rides are available to passengers as soon as possible. A substantial delay in provision of a ride or allocation of a driver may be unacceptable. The disclosed systems and methods perform a more optimal allocation or drivers to passengers by taking into account the significant amount of data related to drivers and passengers.

The disclosed systems and methods do this in a manner that is computationally efficient and meet the latency constrains of operating the ridesharing service. Some embodiments perform an allocation of drivers and passengers to mitigate safety risks or potential incidents that may arise.

A typical lifecycle of a ride through a ridesharing service comprises a customer requesting a ride through their smartphone. A driver is assigned to the customer and the ride commences after the driver picks up the passenger. The ride concludes when the passenger is dropped off. Between the request for a ride and the drop off, several computer systems communicate with each other to facilitate the ride and generate meaningful data. The generated data is leveraged by the disclosed systems and method to perform risk management and improve the experience of passengers by optimizing allocation of drivers to passengers.

Safety is a major concern in the ridesharing industry, for both passengers and drivers. Hailing a ridesharing vehicle as a means for transport is very convenient, however, getting into a vehicle with a complete stranger can be nerve-wracking for some individuals causing them to refrain from doing so despite the convenience. In particular, certain passengers may have a preference to be paired with a specific type of driver in order to make them feel safer and have a more optimal ridesharing experience.

Conventional ridesharing platform systems allocate drivers to passengers based on operational efficiency of providing the ride. Operational efficiency includes the consideration of how close a driver is to a passenger in terms of time and/or distance. The allocation systems and methods of the disclosure go one-step further by introducing user safety as a factor in the allocation process. The systems and methods of the disclosure provide a more optimal balance in managing operational efficiency while improving the likelihood of safe outcomes. The embodiments help reduce risky pairs of passenger and driver combinations to enhance user safety on the platform. This allows the allocation system to prioritize for safety while optimizing for the operational efficiency and user experience.

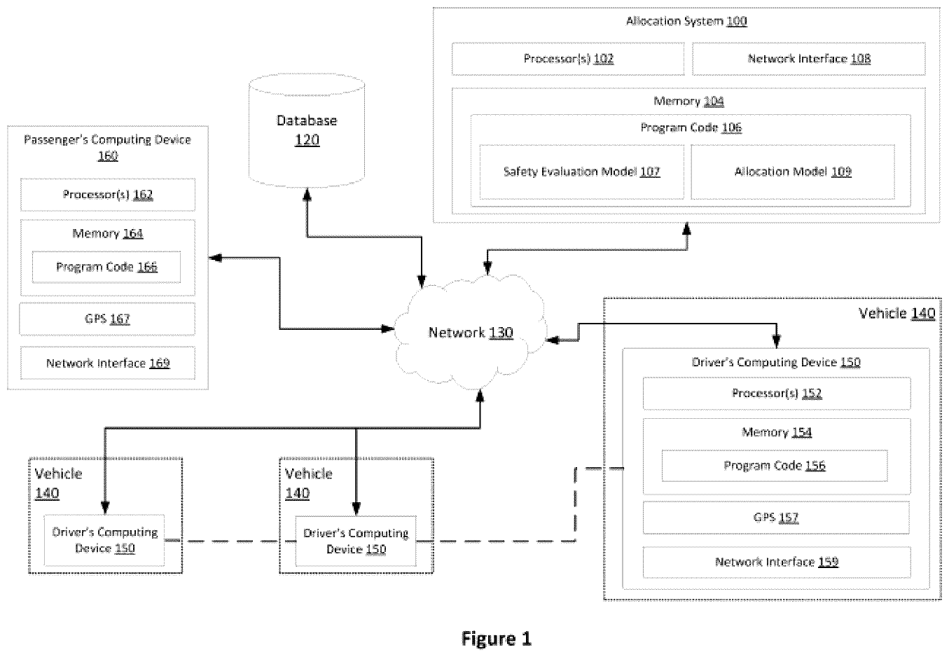

FIG. 1 illustrates a block diagram of a system for optimal allocation and its associated components. An allocation system 100 comprises at least one processor 102, memory 104 accessible to the processor 102 and a network interface 108 to facilitate communication with a plurality of driver's computing devices 150 and a user's computing device 160. Program code 106 provided in memory 104 comprises instructions executable by the processor 102 to perform at least a part of the method of the embodiments described herein. Notably, while individual computer systems are described in FIG. 1, any such computer system may be distributed across multiple servers or multiple devices, or some functionality may be consolidated into a single server or device, without departing from the purposive intent of the present disclosure.

The driver's computing device 150 is associated with a specific vehicle 140 driven by the respective driver. The driver's computing device 150 comprises at least one processor 150, a memory 154, a GPS device 157 and a network interface 159. The memory 154 comprises program code 156 comprising instructions executable by the processor 152 to facilitate interactions with the rideshare risk management system 100. The user's computing device 160 comprises one or more processors 162, a memory 164, a GPS device and a network interface 169. The memory 164 comprises program code 166 comprising instructions executable by the processor 162 to facilitate interactions with the rideshare risk management system 100. The driver's computing device and the user's computing device may include a personal or handheld computing device such as a smartphone or a tablet. Network 130 facilitates communication between the various devices and may include one or more communication networks including the internet, cell phone networks etc.

One or more database 120 are also accessible to the system 100. The database 120 comprises passenger and driver records. The records may include historical data relating to rides taken by passengers or rides provided by drivers and associated information. The historical data relating to the rides may include time, date of the ride, origin, destination of the ride, review data, feedback or comments by passengers and drivers provided in relation to a ride. Review or feedback data indicates whether the experience of a passenger had been positive, negative or neutral for a particular ride. The database 120 may also include biographical details relating to passengers and drivers including information collected during identity verification of the passengers or drivers, payment related details etc. The database 120 may also comprise historical data relating to past incidents that a passenger or driver may have been involved in.

The allocation system considers the information available through the database 120 in assessing the most optimal allocation of a driver to a passenger's request for a ride. In doing so, the allocation system optimizes multiple aspects of the ridesharing service. The optimized aspects include safety outcomes, passenger ride experience, and latency of the ridesharing service.

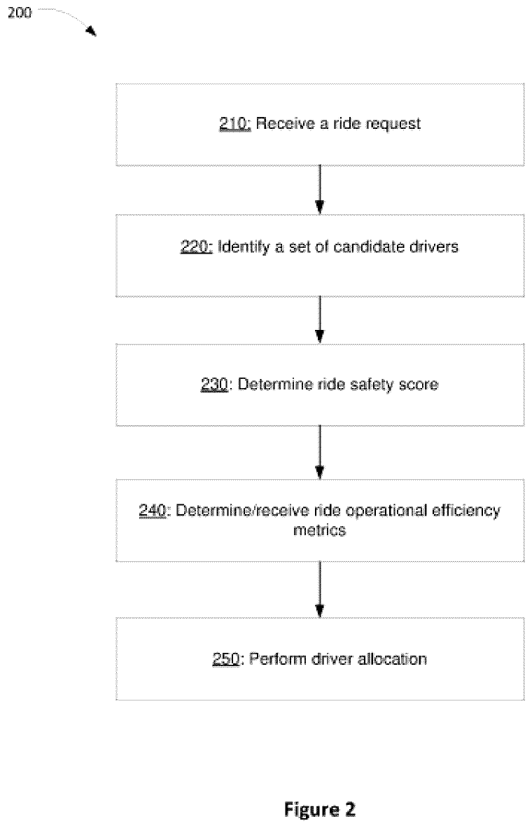

FIG. 2 illustrates a flowchart of a method 200 of optimal allocation executable by the system 100. Particular embodiments may repeat one or more steps of the method of FIG. 2, where appropriate. Although this disclosure describes and illustrates particular steps of the method of FIG. 2 as occurring in a particular order, this disclosure contemplates any suitable steps of the method of FIG. 2 occurring in any suitable order. Depending on the characteristics of the passengers and drivers derived from the data in database 120, the method identifies matches between passengers and drivers that may potentially reduce the likelihood of incidents and improve safety.

At step 210, the system 100 receives a request for a ride from the passenger's device 160. The request may be conveyed through other components of a ridesharing system or platform. The request comprises origin, destination information, time of ride and identity of one or more passengers requesting the ride. In other embodiments, greater or fewer data points (i.e. destination information, time of ride etc) may be captured depending on the data used in the driver allocation process.

At step 220, the system 100 identifies a set of candidate drivers available for the requested ride. The set of candidate drivers are identified from a pool of available drivers based on one or more factors including: location of the passenger/pickup point, availability of the drivers, etc. The set of candidate drivers may be determined based on drivers that are available (i.e. not currently undertaking a ride), are near their drop-off point—e.g. within 5 mins of dropping off the current passenger—have a drop-off point near the passenger who made the request for the ride, are within a predetermined distance or time from the origin—e.g. 5 km or 10 mins—and so on. In some embodiments, system 100 may receive data relating to the set of candidate drivers from an associated system of the ridesharing platform responsible for identifying the set of candidate drivers.

At step 230, ride safety scores are determined using the safety evaluation model 107. The ride safety scores are determined for each driver in the identified set of candidate drivers. The safety evaluation model 107 comprises a plurality of safety evaluation rules to process the driver and passenger records and generate the ride safety scores. The safety evaluation rules may comprise propositional logic rules, arithmetic rules, linear computation rules, probabilistic reasoning rules, or a combination or one or more categories of computational rules, each of which is applied—e.g. to the relevant risk indicators—to produce a score (ride safety score). The various safety evaluation rules of the model 107 may be updated over time based on safety related outcomes. New safety evaluation rules may be added or existing rules may be discarded/modified based on new information made available to the system 100. The generated ride safety scores are indicative of a degree of perceived safety of a pairing of a passenger with a particular driver. A higher safety score for a driver pairing may indicate a greater degree of safety and less likelihood of safety related incidents in a ride provided by the driver to the requesting passenger.

The safety evaluation model through its various rules may take into account a plurality of risk indicators generated based on the passenger's records accessible to the system 100. The risk indicators are each a numerical representation of the various dimensions of risk related data available to the system 100. The risk indicator may include one or more of: passenger biographical record (e.g. different age categories or ranges, and/or gender, may correspond to different numbers), passenger interaction review indicator (e.g. numerical “star-rating”), or passenger incident indicator.

The passenger biographical record includes the gender of the passenger, the passenger's age, and other relevant biographical details of the passenger. Passenger interaction review indicator relates to reviews the passenger may have received from drivers over their past use of the ridesharing service. Low or poor reviews serve as an indicator of higher risk posed by the passenger to the driver. While high or good reviews serve as indicators of lower risk. Passenger incident indicator relates to records of any incidents that passenger may have previously been involved in or records of criminal behavior or negative behavior. The incidents may relate to incidents stored in database 120. Such third party sources may include sources tracking financial or payment related incidents such as the STRO (Suspicious Transaction Reporting Office) Online Notices and Reporting platform (SONAR). Each of the indicators are represented in a numerical form, with their respective values indicating a degree of safety risk associated with the passenger. Each indicator may be assigned a specific weight reflecting the degree to which they meaningfully represent the degree of safety risk associated with a passenger.

In addition, the safety evaluation model also takes into account a plurality of risk indicators generated based on the driver's records accessible to the system 100. The risk indicators include: driver biographical record indicator, driver interaction review indicator and driver incident indicator. The driver related indicators are computed in the same manner as the passenger related indicators as described above. The driver related indicators represent aspects of safety risk related to the driver. The safety evaluation model, for each passenger driver pair takes into account the indicators associated with each of them to determine the ride safety scores.

In some embodiments, the ride safety scores may be tiered or may be associated with a specific category. For example, the ride safety score may be one of:
1: This will result in a deallocation treatment whereby, a passenger-driver pairing will be completely disregarded by the allocation model at step 250.
0.99: This will result in a deprioritization treatment whereby the allocation model will be less likely to assign a deprioritized driver to a passenger when viewed in combination with the operational efficiency metric.
1: This will result in a prioritization treatment whereby the allocation model will more likely assign a prioritized driver to a passenger from the pool of candidate drivers.
0: This results in no treatment whereby the allocation model will treat drivers associated with this score neutrally.

The table below exemplifies some rules that may be implemented by the safety evaluation mode to estimate the safety scores:

TABLE 1
Examples of Rules of Safety Evaluation Model

| | Safety | Treatment in | Passenger | Driver |
|---|---|---|---|---|
| Rule Example | Score | Allocation | gender | gender |
| Female Passenger - | 1 | Prioritize | Female | Female |
| Female Driver | | | | |
| Female passenger - | −0.99 | Deprioritize | Female | Male |
| Male driver with review | | | | |
| indicator below a first | | | | |
| threshold | | | | |
| Male passenger with a | −1 | Deallocate | Male | Female |
| review indicator below a | | | | |
| second threshold - | | | | |
| Female driver | | | | |

The above numerical values are merely exemplary and differently configured safety evaluation models may generate different score of varying values/scales. In some embodiments, the ride safety score may have continuous values as opposed to discrete values exemplified above.

The safety evaluation model may also process one or more ride request conditions received with the ride request to determine the ride safety score. The ride request conditions include one or more of: ride time of day, ride origin, or ride destination, or ride duration. The ride request conditions may influence the assessment of risk associated with a ride and the safety evaluation model may comprise specific rules to process the ride request conditions. For example, female driver or passengers may be allocated passengers/driver of a further lower risk late at night to provide greater safety.

At step 240, the allocation system determines or receives ride efficiency metrics associated with each of the drivers in the set of candidate drivers identified at step 220. The ride efficiency metrics are a representation of how well placed a driver is to efficiently provide the requested ride. The metric may be based on the estimated arrival time of the driver at the requested pick up location. The metric may be represented as an estimate of time in seconds or minutes the driver will be able to pick up the passenger. In some embodiments, the system 100 may determine the ride efficiency metric based on the location information of the drivers. Alternatively, a related system may independently compute the ride efficiency metric and transmit the computed ride efficiency metric to system 100 for factoring into step 250 for driver allocation.

At step 250, the allocation model 109 allocates a specific driver to the passenger by based on the ride safety score and the ride operational efficiency metric. The allocation model may be implemented using a regression model or a machine learning model that evaluates an overall suitability score of a passenger driver combination. A passenger is paired with a driver with the highest suitability score. The suitability score computed by the allocation model serves to unify the information embedded in the ride safety score and the ride operational efficiency metric in a single suitability metric. The allocation model may comprise weights associated with the ride safety score and the ride operational efficiency metric. Using the respective weights, safety score and the operational efficiency metric, the allocation model determines the overall suitability score for each passenger-driver combination. A passenger is allocated a driver with the highest suitability score. In some embodiments, step 250 is performed for a subset of drivers based on the ride safety scores. For example, driver-passenger combinations with a ride safety score below a predefined threshold (e.g. −1) may be disregarded in step 250. Similarly, driver-passenger combinations with an operational efficiency score below a predefined threshold may be disregarded at step 250.

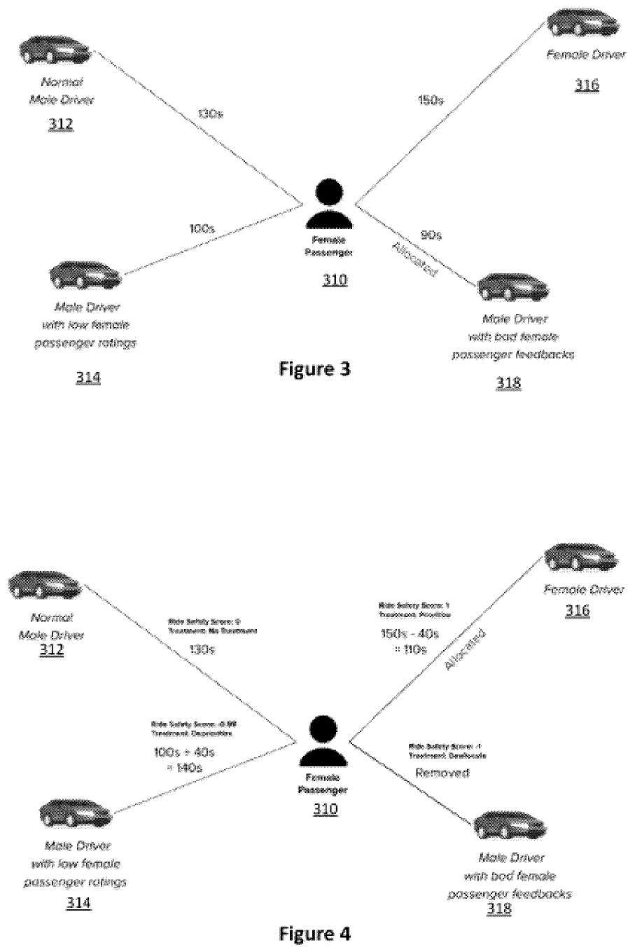

FIGS. 3 and 4 illustrate the difference in terms of how a driver is allocated to a passenger with and without the optimal allocation method 200. FIG. 3 relates to a scenario for a ridesharing platform that does not incorporate the disclosed optimal allocation systems/methods. If the scenario of FIG. 3, the passenger 310 is allocated to driver 318 purely on the basis of the expected time of arrival (ETA) of 90 s being lower than the rest of the drivers. However, undesirably the driver 318 has a history of negative feedback from female passengers. The allocation of the passenger 310 to the driver 318 is a suboptimal outcome and may be a potential safety risk.

FIG. 4 represents a scenario wherein the same passenger 310 is being allocated to one of the drivers 312, 314, 316 and 318 with the assistance of the disclosed allocation system and methods. The allocation system considers a combination of the operation efficiency metric (ETAs) and ride safety scores. In the example of FIG. 4, the ETA for driver 316 has been discounted to factor in a higher ride safety score of the passenger driver combination. Similarly, the ETA for driver 314 has been inflated to account for the low ride safety score due to the low female passenger ratings. The ETA for driver 312 has been left unchanged. Due to the poor ratings of driver 318, the driver 318 has been discarded from consideration altogether. With the adjusted ETAs that serve as a proxy for the suitability scores, the driver 316 is allocated to the passenger over the rest of the drivers. The allocation of the driver 316 represents a more optimal outcome that factors in a combination of both the operational efficiency and the safety dimension in allocation.

Some embodiments relate to methods and systems for computation of a safety score for a pairing of a driver with a passenger. Such embodiments compute the safety score based on passenger and driver records processed by a safety evaluation model. The safety evaluation model comprises a plurality of safety evaluation rules to process the driver's and passenger's records, and the ride safety score is determined based on a combination of the outputs of the plurality of safety evaluation rules.

Some embodiments are directed to methods and systems for allocation of a driver (among a set of candidate drivers) to a passenger's request for a ride. The allocation is performed based on a combination of an operational efficiency metric and safety scores received by the system performing the allocation.

Some embodiments are directed to one or more non-transitory computer-readable storage media storing instructions that when executed by one or more processors cause the one or more processors to perform the method of allocation of a driver to a passenger.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavor to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Although this disclosure describes or illustrates particular embodiments as providing particular advantages, particular embodiments may provide none, some, or all of these advantages.

What is claimed is:

1. A system for allocation of a driver to a passenger, the system comprising:
one or more processors (processor(s));
a memory accessible to the processor(s);
a database comprising a plurality of passenger and driver records accessible to the processor(s);
the memory comprising program code executable by the processor(s) to:
receive a request for a ride from a passenger's computing device; identify a set of candidate drivers for the ride based on location information in the request;
determine, using a safety evaluation model, a ride safety score for each driver in the set of candidate drivers based on the driver's records and the passenger's records;
determine a ride operational efficiency metric for each driver in the set of candidate drivers;
allocate, using an allocation model, a designated driver to the passenger based on the ride safety score and the ride operational efficiency metric.

2. The system of claim 1, wherein the safety evaluation model comprises a plurality of safety evaluation rules to process the driver's records and passenger's records, and the ride safety score is determined based on a combination of the outputs of the plurality of safety evaluation rules.

3. The system of claim 1, wherein the allocation model comprises weights associated with the ride safety score and the ride operational efficiency metric to evaluate suitability of each driver in the set of candidate drivers by calculating a suitability score using the weights, ride safety score and the operational efficiency metric.

4. The system of claim 1, wherein the safety evaluation model also processes one or more ride request conditions received with the ride request to determine the ride safety score.

5. The system of claim 4, wherein the ride request conditions include one or more of: ride time of day, ride origin, or ride destination, or ride duration.

6. The system of claim 1, wherein the safety evaluation model determines the ride safety score based on a plurality of risk indicators generated based on the passenger's records, optionally wherein the risk indicators comprise one or more of:
passenger biographical record,
passenger interaction review indicator, and
passenger incident indicator.

7. The system of claim 1, wherein safety evaluation model determines the ride safety score based on a plurality of risk indicators generated based on the driver's records, optionally wherein the risk indicators comprise one or more of:
driver biographical record,
driver interaction review indicator, and
driver incident indicator.

8. The system of claim 6, wherein each indicator is assigned a relative weight and the risk safety score is determined based on the indicators and the relative weights.

9. The system of claim 1, wherein each driver in the set of candidate drivers is classified into one of a plurality of allocation priority categories based on the ride safety score, optionally wherein the allocation priority categories include: a prioritized category and a deprioritized category.

10. The system of claim 9, wherein the allocation model allocates a designated driver from among the drivers in the prioritized category.

11. A computer-implemented method for allocation of a driver to a passenger, the method comprising:
receiving a request for a ride from a passenger's computing device; identifying a set of candidate drivers for the ride based location information in the request;
determining, using a safety evaluation model, a ride safety score for each driver in the set of candidate drivers based on the driver's records and the passenger's records;
determining a ride operational efficiency metric for each driver in the set of candidate drivers;
allocating, using an allocation model, a designated driver to the passenger based on the ride safety score and the ride operational efficiency metric.

12. The method of claim 11, wherein the safety evaluation model comprises a plurality of safety evaluation rules to process the driver's and passenger's records, and the ride safety score is determined based on a combination of the outputs of the plurality of safety evaluation rules.

13. The method of claim 11, wherein the allocation model comprises weights associated with the ride safety score and the ride operational efficiency metric to evaluate suitability of each driver in the set of candidate drivers by calculating a suitability score using the weights, ride safety score and the operational efficiency metric.

14. The method of claim 11, wherein the safety evaluation model also process one or more ride request conditions received with the ride request to determine the ride safety score.

15. The method of claim 14, wherein the ride request conditions include one or more of: ride time of day, ride origin, or ride destination, or ride duration.

16. The method of claim 11, wherein the safety evaluation model determines the ride safety score based on a plurality of risk indicators generated based on the passenger's records, optionally wherein the risk indicators comprise one or more of:
passenger biographical record,
passenger interaction review indicator, and
passenger incident indicator.

17. The method of claim 11, wherein safety evaluation model determined the ride safety score based on a plurality of risk indicators generated based on the driver's records, optionally wherein the risk indicators comprise one or more of:
driver biographical record,
driver interaction review indicator, and
driver incident indicator.

18. The method of claim 16, wherein each indicator is assigned a relative weight and the risk safety score is determined based on the indicators and the relative weights.

19. The method of claim 11, wherein each driver in the set of candidate drivers is classified into one of a plurality of allocation priority categories based on the ride safety score, optionally wherein the allocation priority categories include: a prioritized category and a deprioritized category.

20. The method of claim 19, wherein the allocation model allocates a designated driver among the drivers in the prioritized category.
